(19) United States
(12) Patent Application Publication
(10) Pub. No.: US 2025/0138613 A1
(43) Pub. Date: May 1, 2025

(54) SMART POWER STRIP SUPPLY FOR ELECTRONICS

(71) Applicant: Jonathan Lopez, Shelton, CT (US)

(72) Inventor: Jonathan Lopez, Shelton, CT (US)

(21) Appl. No.: 18/497,357

(22) Filed: Oct. 30, 2023

(51) Int. Cl. G06F 1/26

(52) U.S. Cl. CPC G06F 1/266

(57) ABSTRACT

A smart power strip having a plurality of first electrical contacts along a surface adjacent a track along which a plurality of power plugs can be selectively slid and locked in place to form customized arrangements of different power plugs along the smart power strip. Each power plug provides one of the following power and data interfaces: two-prong power, three-prong power, USB, and HDMI interfaces along a first face thereof, and wherein along an opposing second face each power plug provides a plurality of second electrical contacts for operatively associating a subset of the first electrical contacts, whereby each power plug is selective controllable and readable by a software application. The present invention also provides one or more spacers which can be locked along the track to selectively space apart each interchangeable power plug.

### BACKGROUND OF THE INVENTION

The present invention relates to power supplies and, more particularly, to a smart power strip supply for electronics.

Electronic devices come with different size power plugs, some small and others larger. When using different size plugs, one sometimes encounters the issue of not having enough outlets or ports to plug in their devices into a wall outlet or power supply strip. Thereby, limiting the number of devices that can be simultaneously powered.

Currently, electronic power supply strips affording more ports than a standard wall outlet, but they too have limitation and inefficiencies in that the power strip may have eight ports, but because of the bulkiness of one or more power plugs, some power plugs cannot be accessed, or because device needs four of those eight power plugs to operatively associate with a USB plug, and they have no adapter, they cannot use all eight power ports. Furthermore, current power supply strips do not enable remote control of each power port.

In other words, standard power supply strips limit the number of devices that can connect thereto when they do not account for the fact that electronic devices and their power supply plug types vary by manufacturer. Thereby preventing access for some devices to power ports, in part due to different size plugs made by tech companies.

As can be seen, there is a need for a smart power strip supply for electronics, wherein the smart power strip allows for control of how much space is in between each power plug and the final number of different power ports along the power strip with detachable and moveable power ports, wherein the smart power strip also enables remote accessing to electrical connections.

### SUMMARY OF THE INVENTION

The present invention enables customization of and thus accessibility to power ports for variously sized power plugs and data connection interfaces.

The present invention enables remote access to power and data ports via a software application, facilitating control and management of devices connected and to the smart power strip.

This smart power supply embodied in the present invention allows users to manually slide and selectively arrange smart power ports, enabling users to selectively space apart power plug to accommodate differently sized power plugs as well as provide one smart power strip is as many data connection interfaces needed in any give scenario.

In one aspect of the present invention, a power strip includes the following: a base power strip having a plurality of first electrical contacts spaced apart along a first surface thereof; a track along the base power strip; one or more power plugs dimensioned and shaped to be slidable along the track; and each power plug having a first face and a second face facing away from the first face, wherein the first face has one of the following power and data interfaces: a two-prong power interface, a three-prong power interface, a USB data interface, a HDMI data interface and a Thunderbolt™ interface, and wherein the second face provides a plurality of second electrical contacts arranged to operatively associate with a subset of the plurality of first electrical contacts.

In another aspect of the present invention, the power strip further provides wherein each power plug has a C-shape, wherein opposing end portions of the C-shape operatively associate with the track for sliding there along, wherein each power plug is movable between a locked condition and an unlocked condition relative to the track so as to be slidable there along, wherein each power plug provides a plug release button to move between the locked and unlocked conditions, wherein track is a magnetic power track slide; further providing one or more spaces for selective arranging along the base power strip relative to the one or more power plugs, wherein each spacer has a C-shape, wherein opposing end portions of the C-shape operatively associate with the track for sliding there along in an unlocked condition, wherein each space provide a spacer release button for moving the spacer between a locked condition and the unlocked condition relative to the track; further providing a software application operatively associated with the plurality of first electrical contacts for controlling data electrically transferred to the second electrical contacts, wherein the software application enables naming of each power plug, activation and deactivation of each power plug, and to electrically transmit power consumption of each power plug; and further providing a display screen along the first surface.

These and other features, aspects and advantages of the present invention will become better understood with reference to the following drawings, description and claims.

### BRIEF DESCRIPTION OF THE DRAWINGS

FIG. 1 is a top perspective view of an exemplary embodiment of a smart power strip 10 of the present invention.

FIG. 2 is an exploded perspective view of an exemplary embodiment of the smart power strip 10 of the present invention.

FIG. 3 is a bottom perspective view of an exemplary embodiment of a smart power port 12 of the present invention.

FIG. 4 is a top plan view of an exemplary embodiment 40A of the present invention, shown in use illustrating a smart power strip 10 arranged to enable at least four power cords 24A and a USB cord 26A.

FIG. 5 is a top plan view of an exemplary embodiment 40B of the present invention, illustrating how the same smart power strip 10 of FIG. 4 rearranged to enable three power cords 24A, a USB cord 26A, and a HDMI cord 28A.

FIG. 6 is a block diagram 50 of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

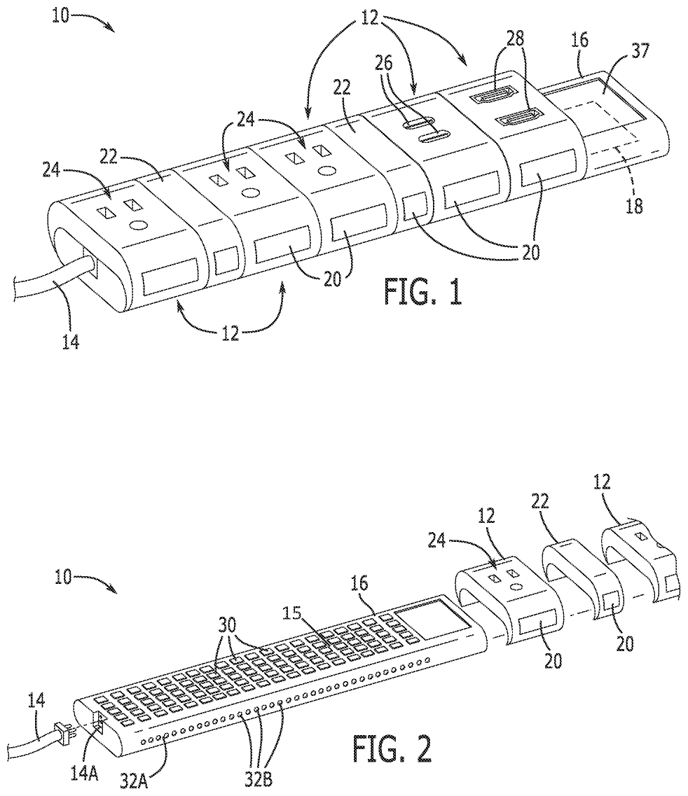

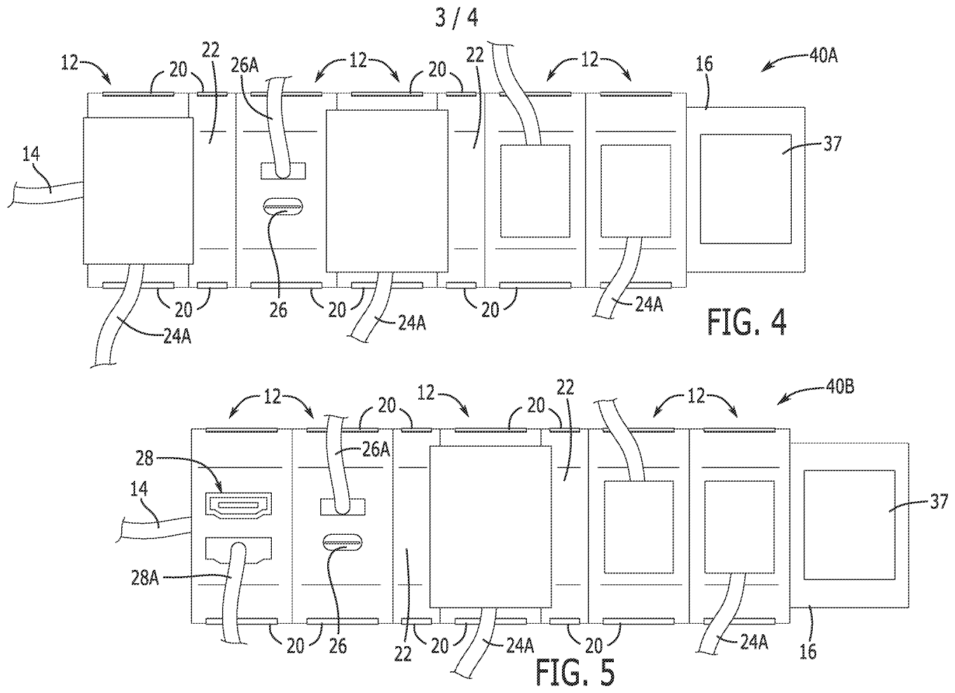

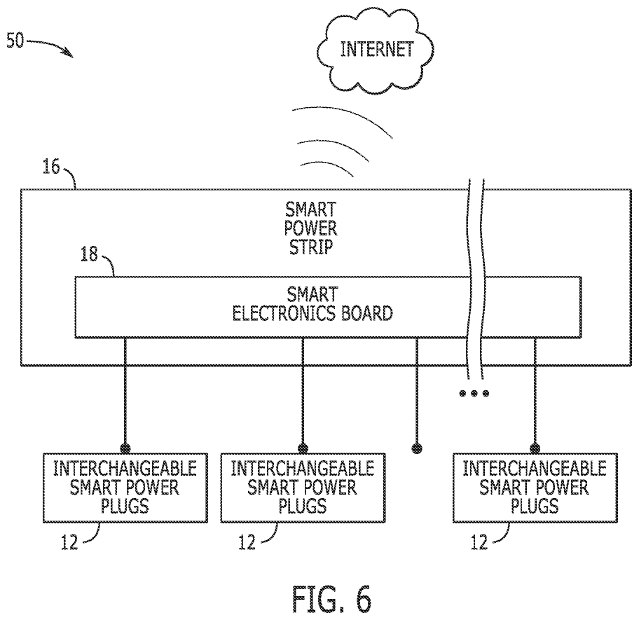

Referring to FIGS. 1 through 6, the present invention provides a configurable smart power strip 10. The configurable smart power strip 10 provides a base power strip 16 that can be removably connected to a power supply 14 by way of a detachable power and data connector 14A enabled to carry and transfer data and provide power (via the power supply 14) via a plurality of power and data pins. In some, but not all, embodiments, the detachable power and data connector 14A may be a USB-C adapter for computer connection. The base power strip 16 provides a plurality of first electrical contacts 30 that may be spaced apart along at least a first surface 15 thereof. One or more first electrical contacts may have a voltage capacity of 110 volts or 120 volts or other standard volt capacities.

The base power strip 16 may be elongated, having a length greater than its cross-sectional width. The cross-sectional width may be an oval, rectangular, or other geometrical and non-geometrical shapes. In some embodiments, the first surface 15 may be an outward “top” face having the largest cross-sectional width. A distal end of the first surface 15 may provide a LED display 37. Embedded with the base power strip 16 may be a smart electronics board 18 configured to enable selective remote control of one or more of the plurality of first electrical contacts 30 to facilitate the disclosure herein.

A sliding track 32A may be provided along one or more lateral side faces (substantially orthogonal to the first surface 15) of the base power strip 16. The sliding track 32A may be magnetic power track with a plurality of magnets 32B, as illustrated in FIG. 2.

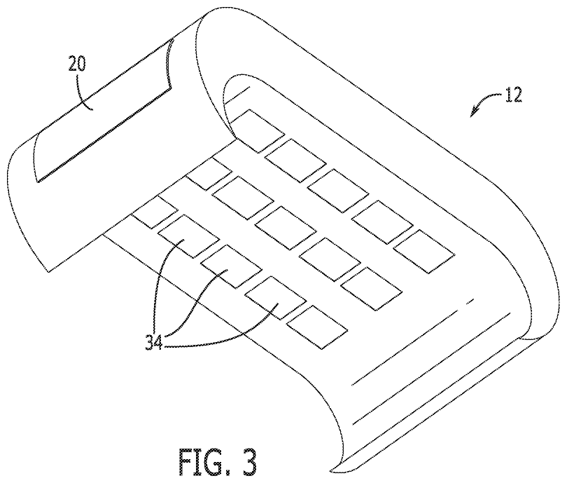

A plurality of smart power plugs 12 may be dimensioned and shaped to slide along the sliding track 32A. Each smart power plug 12 may be generally C-shaped, as illustrated in FIG. 3. The ends or end portions of the ‘C’ may engage the sliding track 32A so that each smart power plug 12 is movable between a locked condition and an unlocked condition along sliding track 32A, whereby each smart power plug 12 may selectively slide along the first surface 15 and even be removed the entire base power strip 16. Each smart power plug 12 may provide a release button 20 to move that smart power plug 12 between the locked and unlocked conditions. Along the outward facing surface of the C-shaped smart power plug 12 one of many different power and data plug configurations may be provided: a two- or three-prong power outlet configuration 24, one or two USB port data configurations 26, one or two HDMI port data configurations 28, and the like.

The underside of each smart power plug 12 provides an adequate arrangement of second electrical contacts 34 to operatively associate with a subset of the first electrical contacts 30 on the first surface 15.

The present invention may include one or more spacers 22 that are also C-shaped, wherein ends or end portions of the ‘C’ may engage the sliding track 32A so that each spacer 22 is movable between a locked condition and an unlocked condition, whereby each smart power plug 12 may selectively slide along the first surface 15 and even off the entire base power strip 16. Each smart power plug 12 may provide a release button 20 to move between the locked and unlocked conditions. The availability of spacers 22 allow a user to selectively space apart different power and data plug configurations, while not exposing the first electrical contacts 30 along the first surface 15 (which would otherwise be a possibilty if there were a gap between two adjacent smart power plugs 12).

The detachable and moveable power ports, that slide through the magnetic power track, or other track or rail that allows the smart power plugs 12 to be customizable locked along the first surface 15 of the base power strip 16.

The smart electronic board 18 are the brains of the operation, configured so that the smart power plugs 12 receive and send data, based on their electrical signals and port types (voltage, USB, HDMI, etc.) to and from the smart power strip 10. Also, the smart electronic board 18 enables remote control of the smart ports, including the ability to deactivate and reactivate.

The power supply 14 enables future accessories and upgrades as well as powering the smart electronics board 18; typically, the power supply 14 may be connected to a 110v or 120v (or other voltage capacity) power outlet.

The magnetic track slide 32A allows a user to selectively arrange a sequence of smart power ports 12 and spacers 22. Thus, if a tech power supply plug is too large to fit it between a pre-existing arrangement of left, middle, and right smart power ports 12, a user may add a spacer 22 or two between the left and right smart power ports 12 to accommodate tech power plug, and so on. Either or both the left and right smart power ports 12 may be slid along the tracks 32A to accommodate the spacers 22 and interchangeable smart power plugs 12.

The present invention affords a user the option of connecting to the smart power strip 10 via a systemic software application, which is configured to provide information on connected devices, including power consumption and ability to re-name plugs to reference, as well as selectively activate and deactivate smart power ports.

Additionally, the present invention can serve as a smart power strip 10, as well as a smart hub for a computer. Through the available power cord attachment port, one can interchange how the device works. With the power and data connector 14A delivering both data and power, a user can convert the smart power strip into a smart computer hub, wherein the option of connecting USB power ports enables accessories options and upgrades.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A power strip comprising:
a base power strip having a plurality of first electrical contacts spaced apart along a first surface thereof;
a track along the base power strip;
one or more power plugs dimensioned and shaped to be slidable along the track; and
each power plug having a first face and a second face facing away from the first face, wherein the first face has one of the following power and data interfaces: a two-prong power interface, a three-prong power interface, a USB data interface, and a HDMI data interface, and wherein the second face provides a plurality of second electrical contacts arranged to operatively associate with a subset of the plurality of first electrical contacts.

2. The power strip of claim 1, wherein each power plug has a C-shape, wherein opposing end portions of the C-shape operatively associate with the track for sliding there along.

3. The power strip of claim 2, wherein each power plug is movable between a locked condition and an unlocked condition relative to the track so as to be slidable there along.

4. The power strip of claim 3, wherein each power plug provides a plug release button to move between the locked and unlocked conditions.

5. The power strip of claim 4, wherein track is a magnetic power track slide.

6. The power strip of claim 5, further comprising one or more spaces for selective arranging along the base power strip relative to the one or more power plugs.

7. The power strip of claim 6, wherein each spacer has a C-shape, wherein opposing end portions of the C-shape operatively associate with the track for sliding there along in an unlocked condition, wherein each space provide a spacer release button for moving the spacer between a locked condition and the unlocked condition relative to the track.

8. The power strip of claim 1, further comprising a software application operatively associated with the plurality of first electrical contacts for controlling data electrically transferred to the second electrical contacts.

9. The power strip of claim 8, wherein the software application enables naming of each power plug, activation and deactivation of each power plug, and to electrically transmit power consumption of each power plug.

10. The power strip of claim 9, further comprising a display screen along the first surface.

11. The power strip of claim 10, wherein the one or more power plugs comprises at least four power plugs, and wherein the one or more spacers comprises at least two spacers.
